(19) United States
(12) Patent Application Publication
(10) Pub. No.: US 2004/0161122 A1
(43) Pub. Date: Aug. 19, 2004

(54) Apparatus for electric to acoustic conversion

(76) Inventor: Karsten Nielsen, Helsingor (DK)

Correspondence Address: HARNESS, DICKEY & PIERCE, P.L.C., P.O. BOX 8910, RESTON, VA, 20195, US

(21) Appl. No.: 10/475,340

(22) PCT Filed: May 16, 2002
(86) PCT No.: PCT/IB02/01668

(30) Foreign Application Priority Data
May 16, 2001 (SE) 0101720-1

(51) Int. Cl. H04B 3/00; H04R 3/00

(52) U.S. Cl. 381/117; 381/111; 381/77

(57) ABSTRACT

The present invention relates to an apparatus for converting an audio signal from a source (25) into audio waves, comprising a modulator (17), for modulating said audio signal, an amplifying switching stage (15), for amplifying a modulated audio signal supplied from the modulator, and a transducer (19). The transducer is connected directly to the switching stage, and is arranged to convert a pulse train from the switching stage into audio waves. Further, the modulator, the switching stage and the conversion means are integrated mechanically and electrically in one operational unit, being connectable directly to a mains power supply (12). By this electrical integration, no separate filtering is required, but instead the inherent qualities of the transducer are used for accomplishing filtering of the pulse train.

### TECHNICAL FIELD

The present invention relates to an apparatus for electric to acoustic conversion, comprising a modulator, an amplifying switching stage and electric-acoustic conversion means. The invention may advantageously be used for improved power conversion in audio reproduction.

### TECHNICAL BACKGROUND

Conventional audio power conversion systems are based on three basic elements, a power supply generating DC voltage, an amplifier being fed by the power supply, and a speaker or transducer being fed with an amplified audio signal from the amplifier. Such a prior art system is illustrated in FIG. 1. In prior art, both linear and high efficiency switched power amplifiers and power supply solutions are known.

In general, the elements in the audio amplification chain are considered as three distinctly different elements and designed as such. The elements are typically connected by cables and connectors to implement the complete system converting energy from mains to the acoustic output.

As an example, power amplifiers are generally designed to drive various types of speakers by audio amplifier manufacturers. The speakers have various resistive and reactive impedance characteristics that the amplifier has to handle in order to be a competitive and useful amplifier. Such design criteria significantly complicates the amplifier design. Also the loudspeaker driver is generally designed to be driven by various types of amplifiers. This flexibility will lead to a more complex implementation than actually needed.

Mechanically, a general audio power conversion system is implemented by three distinct mechanical elements, i.e. that are connected by cable and connectors. Each mechanical element has its own mechanical structure to handle heat development in the system. The cooling requirements of class A and AB amplifiers, which are common in the prior art amplifier designs makes it necessary to separate the components from each other, and especially from the transducer. A high efficiency class D amplifier is therefore preferable in such designs.

In Patent U.S. Pat. No. 6,243,472 (Fully integrated amplified loudspeaker) a physical integration of an amplifier and a transducer is shown.

The most restrictive part of a Class D amplifier is the output filter. This filter leads to increased output impedance which leads to poorer handling of the loudspeaker, complex and expensive control systems due to the 180-degree phase lag and thereby potentially unstability of the total system, bandwidth limitations both in the forward path of the system and in the feedback path, non-linearities in the filter leading to distortion and intermodulation, increased volume and weight due to large size and heavy filter components and peaking due to a high Q factor when the load is removed with potential breakdown as a result, which also leads to the use an efficiency compromising Zobel network. All factors leading to a non-efficient, costly, voluminous, heavy, non-linear and non-stable system.

Prior art systems include a low pass output filter in order to obtain damping of the PWM high frequency spectral components on the output terminals and speaker cables that would otherwise lead to high levels of EMI (Electro Magnetic Interference).

Only very low power systems can obtain allowable EMI characteristics from the speaker cables without filtering. Such filter less class D amplification is shown in U.S. Pat. No. 6,262,632. However, the solution requires complex signal processing, and does not mention physical integration of amplifier and transducer.

The low-pass output filter has also been introduced in order to be able to reduce the power losses in the transducer contributed by the high frequency switching currents. This would potentially cause overheating of the transducer with breakdown as a result.

The voice-coil in a traditional electro-dynamic transducer is produced by conductors that have diameters much larger than the penetration depth of the current at the switching frequency. This leads to a low DC resistance but a high AC resistance, which implies high losses at the switching frequency.

Furthermore the magnetic structure of the transducer is not optimized for high frequency currents leading to severe high frequency losses in the magnetic structure. General audio amplification is neither electrically nor mechanically optimal from any perspective.

Fundamentally, there is much to be gained in a given application by dedicating the elements electronically and by new thinking on the electrical and mechanical implementation.

### OBJECTS OF THE INVENTION

Accordingly, a primary object of the invention is to provide an efficient electric to acoustic power conversion system that overcomes fundamental problems related to conventional power amplification and transducer techniques by electrical dedication of the different elements.

A second object is to provide a system with superior total efficiency, superior audio performance characteristics in terms of improved linearity, significantly improved dynamic range and sound performance level combined with very low Electro Magnetic Interference.

A third object of the invention is to provide an intelligent mechanical solution which much simplifies the mechanical implementation of the complete audio power conversion chain and reduces development costs and improves robustness of the resulting system.

### SUMMARY OF THE INVENTION

These and other objects are achieved by an apparatus described as a Pulse Modulated Transducer (PMT) of the kind mentioned by way of introduction, wherein the electric-acoustic conversion means are connected directly to the switching stage, and are arranged to convert a pulse train from the switching stage into audio waves on the diaphragm of the transducer, and wherein the modulator, the switching stage and the conversion means are integrated mechanically and electrically in one operational unit, being connectable directly to a mains power supply or directly to rectified mains.

The PMT designs can be divided into 2 different categories. AC and DC PMT's characterized by having an AC supply voltage or a DC supply voltage respectively. The AC categories having two additional sub-categories named single stage and two-stage characterized by the number of power stages comprised within the PMT structure. All the possible realizations of PWM generators in the AC and DC PMT can comprise one or a plurality of half-bridges.

According to this solution, the conventional, separate power supply is in some categories of the PMT's practically eliminated by the implementation of a Pulse Modulated Transducer (PMT). The mechanical integration provides for elimination of transfer of the amplified signal through cables and connectors, and thus an improved audio conversion with reduced EMI is obtained.

A requirement for the mechanical integration in medium to high power applications is a high efficiency conversion stage requiring a switching operation to realize a cool and compact power processing section.

If switching technology like PWM or PDM were to be comprised in a conventional amplifier, filtering would be needed to generate an audio signal that can be transferred in the speaker cables. To feed the switching pulse train through the loudspeaker cables would not be possible, as unacceptable levels of EMI would be the result. As prior art has been focused on cable transmission, there has been no way to eliminate the filtering in the amplifier except for very low power applications and low-pass output filter designs.

According to the invention, the power is transferred as a high voltage pulse train, fed directly from the switching stage to the transducer. By this electrical integration, no separate filtering is required, but instead the inherent qualities of the transducer are used for accomplishing filtering of the pulse train and obtaining higher efficiency. Electro-dynamic transducers are partially inductive at typical switching frequencies and the transducer can be optimized with the power stage to minimize high frequency losses.

Solving the potential EMI problem mentioned above is further made practical by the mechanical integration of electronics and transducer. The idea is to implement a highly efficient power section internally in the transducer as a module that is integrated in the system, electronically and mechanically. The mechanical implementation will along with area reduction of which the radiation takes place from, both on the power section and the control loops, contribute to a strong reduction of the EMI.

The PMT saves material for packaging, cooling of amplifier and power supply. Also, as mentioned above, cabling and connecting of elements is eliminated.

Subsequently, the mechanical stability and robustness of the audio power conversion chain can be significantly improved. Total dedication of amplifier section and transducer improves performance with much less error generating components.

Perfect compensation techniques can be implemented (MFB, Microphone based equalization) in the dedicated system. It is obvious e.g. to implement DSP based compensation in the PMT core electronic section.

Protection systems can be simplified by the local implementation of the power conversion inside the PMT.

The PMT idea is the idea of ultimate dedication between the three basic power conversion elements in the audio reproduction chain. The power conversion system is completely integrated electrically and mechanically in the transducer such that the new system—the Pulse Modulated Transducer—can be driven directly from the AC mains or alternatively by a DC input voltage. Another advantageous feature is that the amplifier will never clip if operating from rectified mains voltage.

The source input which may be of the analog or digital type, is connected to the PMT unit directly. The concept is a paradigm in audio power conversion and new to the art.

By using class D or PWM switching technology it is possible to avoid the heat related problems that would occur if an integration of the components of conventional technology were to be attempted.

A further advantageous embodiment of the invention is to use a three-level (Class BD type) PWM wave generated by either carrier means or by a Controlled Oscillation Modulator, e.g. according to WO 98/19391. Another preferred embodiment is to modulate the three-level PWM signal with a Synchronized Controlled Oscillation Modulator, as described in the applicant's Swedish patent application No. 0104401-5, hereby incorporated by reference. As described in Audio Amplifier Techniques With Energy Efficient Power Conversion, Ph.D Thesis, DTU 1998, NBDD or NBDS types have very appealing high frequency characteristics that will be advantageous when driving a transducer directly. Both methods have zero HF components at idle meaning that the losses related to carrier components will be zero at zero modulation. Furthermore the said three level modulation will introduce ripple currents with a peak amplitude proportional to the modulation index M, where M<1. The ripple current will therefore only obtain full peak amplitude at M=1. Furthermore the preferred SCOM modulator will also imply a zero idle loss in the transducer since the differential output signal is zero at idle. Said three-level modulation is therefore advantageous in the PMT system.

The elimination of the output filter also leads to easier control implementation. Since only the transducer voice-coil effects the phase of the forward path of the audio chain there is plenty of phase margin in order to keep an inherently stable system. Therefore there is no longer need for phase lead and lag compensation in the feedback path as is done in the applicant's patent U.S. Pat. No. 6,297,692, entitled “Pulse Modulation power amplifier with enhanced cascade control method”, hereby incorporated by reference.

Preferably the feedback path can be implemented as a voltage division and low-pass filtering of the output PWM signal of the PWM generator.

Preferably, the switching electronics is implemented on a substrate with e.g. die wire bonding techniques, said substrate utilizing the transducer itself for cooling. It is especially the transducer magnetic structure that has significant thermal capacity. This arrangement secures low temperature operation of the power processing element and a minimal volume to minimize the resulting volume of the PMT.

### BRIEF DESCRIPTION OF THE DRAWINGS

The preferred embodiment of the present invention will be further described in the following, with reference to the appended drawings.

FIG. 1 shows a prior art power conversion system with three distinct elements, the power supply, the power amplifier and the electro-dynamic transducer.

FIG. 2 Shows a prior art system comprising a physical integration of a power supply, a class D amplifier and a transducer without any dedication towards each other. Furthermore comprising an output filter as any other class D amplifier would.

FIG. 3 shows a schematic of a prior art system where a non-optimized transducer is driven directly by a PWM generator over speaker cables.

FIG. 4 shows a schematic view of a pulse modulated transducer according to a preferred embodiment of the invention.

FIG. 5 shows a Single stage AC PMT which is a possible realization of the PMT in FIG. 4.

FIG. 6 Shows a possible implementation of the Two stage AC PMT comprising a dedicated single ended power supply, a dedicated PWM generator implemented as a full-bridge power stage and a dedicated electro-dynamic transducer.

FIG. 7 Shows a two stage AC PMT comprising a dedicated PWM generator implemented as a half-bridge power stage. Furthermore comprising a dedicated electro-dynamic transducer and a dedicated single ended power supply feeding the PWM generator.

FIG. 8 Shows a possible implementation of a DC PMT. The DC PMT comprising a dedicated dual/balanced ended power supply, a dedicated PWM generator implemented as a half-bridge power stage and a dedicated electro-dynamic transducer.

FIG. 9 shows another possible implementation of a DC PMT. The DC PMT comprises a dedicated single ended power supply, a dedicated PWM generator implemented as a two half-bridge power stage and a dedicated electro-dynamic transducer.

FIG. 10 Shows the input impedance of an electro-dynamic transducer placed in a closed box.

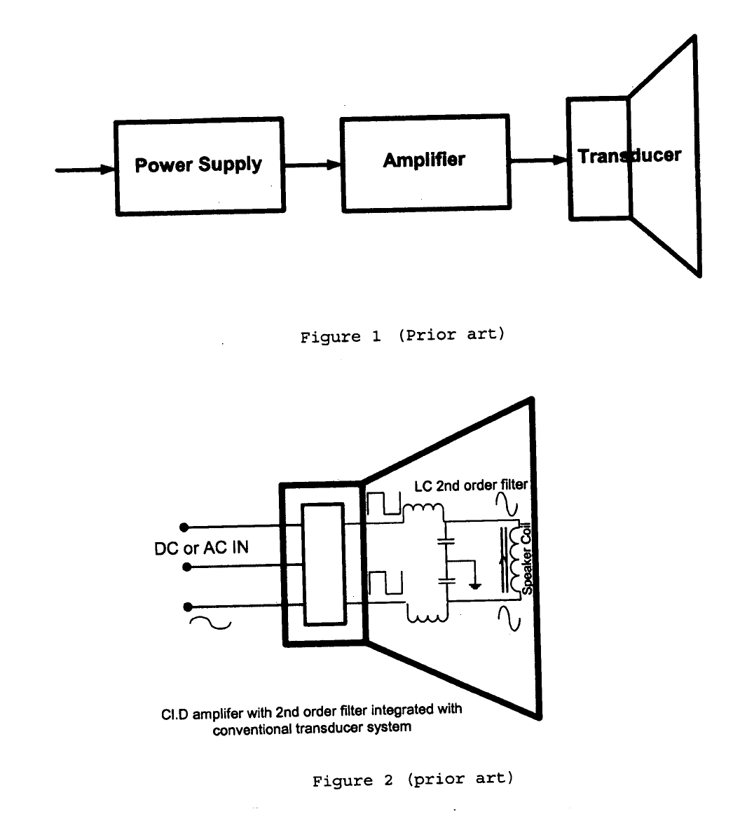

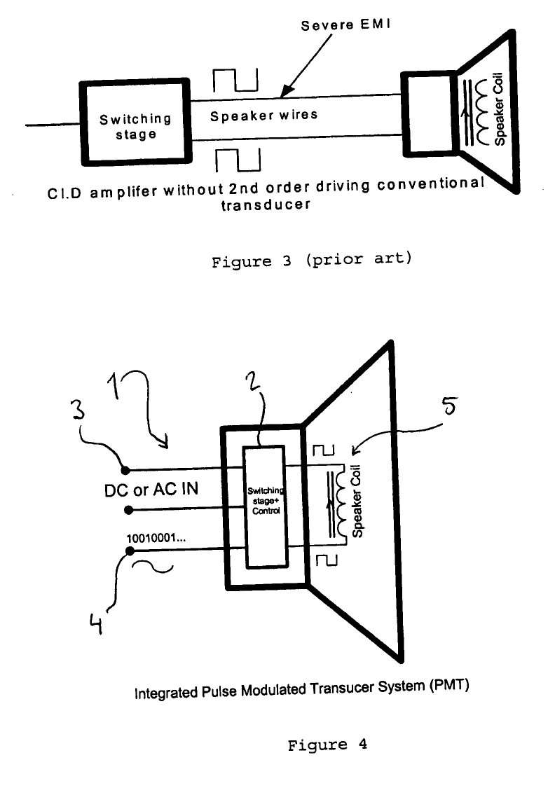

### DETAILED DESCRIPTION OF A PREFERRED EMBODIMENT

A schematic view of a Pulse Modulated Transducer 1 according to an embodiment of the invention is illustrated in FIG. 4. The power conversion can be implemented in a single conversion stage 2, switching directly from the rectified mains 3.

General to all preferred embodiments is that the modulator may be analog or digital and of PWM or PDM type in general. A “Controlled Oscillation modulator” can referably produce the pulse waveform as described in the applicant's patent number U.S. Pat. No. 6,362,702 or a synchronized Controlled Oscillation Modulator preferably producing a 3-level (Class BD type) PWM pulse waveform or a digital PWM modulator in general producing such a signal. This implementation will lead to lower losses in the voice-coil and magnetic structure of the electro-dynamic transducer. The modulating signal will be based on the source input 4 (analog or digital) and possibly also processed feedback information. Many feedback principles are viable in the PMT topology, examples are: voltage, current, motional feedback from transducer and microphone feedback. Individuals skilled in the art of transducer compensation will find that many methods can be successfully applied in the PMT topology. Even control systems based on those used in class A, B and AB are viable since the output filter has been eliminated and the resulting phase lag on the output of the PWM generator will be approximately 0 degrees. This is of great importance since a control system with wide bandwidth and resulting wide band noise suppression can be comprised in the design.

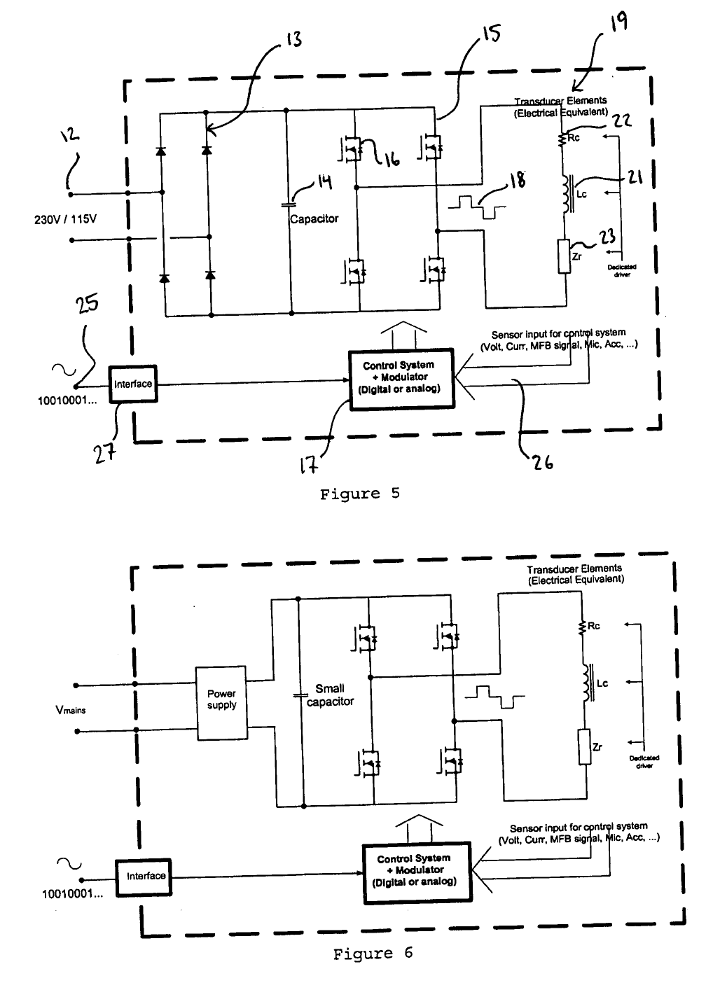

The single stage AC PMT is shown in FIG. 5, as an embodiment of the invention. A single pulse modulated switching power conversion stage is used for the conversion from AC mains to a high quality pulse modulated power signal driving the transducer 5. The inductive load is driven directly by the switching power stage, hence the designation—Pulse Modulated Transducer (PMT). The powerstage is shown as two half-bridges but can be realized as a half-bridge or a plurality of half-bridges. The PMT interface can comprise galvanic isolation.

Further details of a preferred embodiment are also illustrated in FIG. 5 showing a PMT as one integrated unit 11. In this case, an AC input 12 is rectified by a diode bridge 13 and buffered by a capacitor 14. The resulting rectified mains signal directly drives a H-bridge 15 with power switches 16 that are intelligently controlled by a modulator 17. The switching technology is of PWM type, resulting in very low heat generation. The pulse modulated power signal 17 generated by the switching stage drives the electro-dynamic transducer 19.

The transducer 19 is schematically represented by an electrical equivalent, comprising an inductance 21 and a resistance 22, with an additional reactive part 23 representing the mechanics.

The modulator 17 is connected to a low-voltage audio source 25, which may be digital or analogue, and modulates this source signal to control the H-bridge switching stage 15. The modulator 17 preferably comprises a complete control system, and is the provided with a plurality of feedback signals 26 from the transducer, such as voltage, current, audio reproduction signals, etc.

In the illustrated example, the source 25 is isolated from the modulator 17 by optical means 27, to secure galvanic isolation of the system. This elegantly secures galvanic isolation of the complete audio power conversion chain.

The switching stage 15 can be implemented on an aluminum substrate with die wire bonding, and the substrate uses the transducer magnetic structure for cooling.

The example system in FIG. 5 dramatically simplifies the general audio power conversion chain in terms of electronic and mechanical hardware complexity. The complete audio power conversion chain will be implemented without magnetic's at all.

Another embodiment of the AC PMT is shown in FIG. 6 as a two stage AC PMT where a power supply is integrated in the PMT structure. The power supply can be realized as a single or a dual supply. Furthermore, the PMT PWM generator power stage preferably can be implemented as two half-bridges but also can be implemented as a single half-bridge or as a plurality of half-bridges. The galvanic isolation can be obtained in the Power supply or within the interface of the PMT.

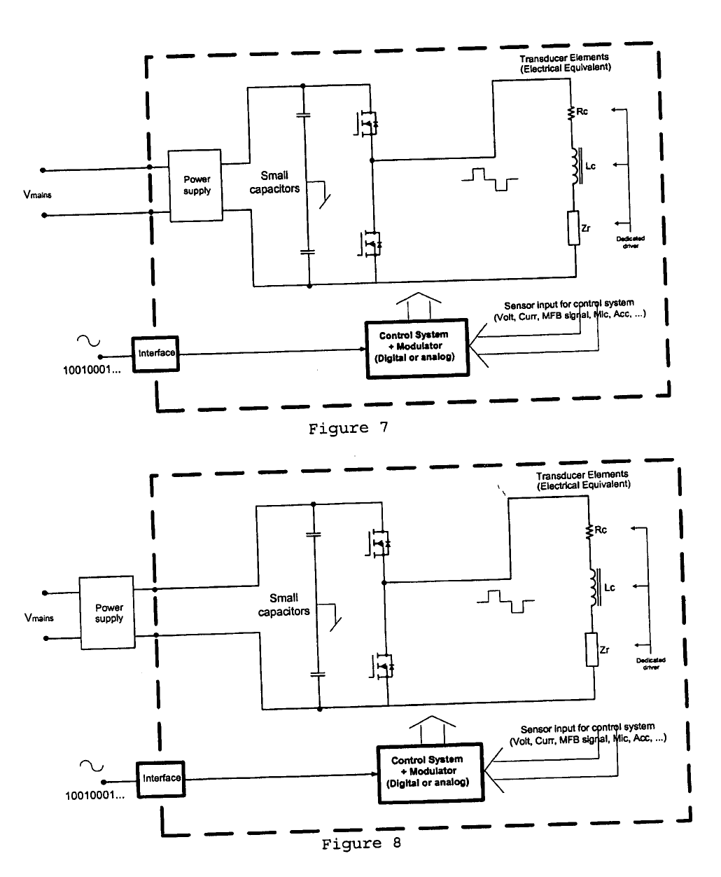

The DC PMT is shown in FIG. 7 as a single ended version fed by a DC power supply placed externally to the PMT. The power supply can feed one or a plurality of PMT's. The PMT power stage can comprise one or a plurality of half-bridges. A small capacitor can be inserted over the power stage supply terminals in order to meet the ripple requirements. Galvanic isolation can be introduced in the Power supply or in the interface of the PMT.

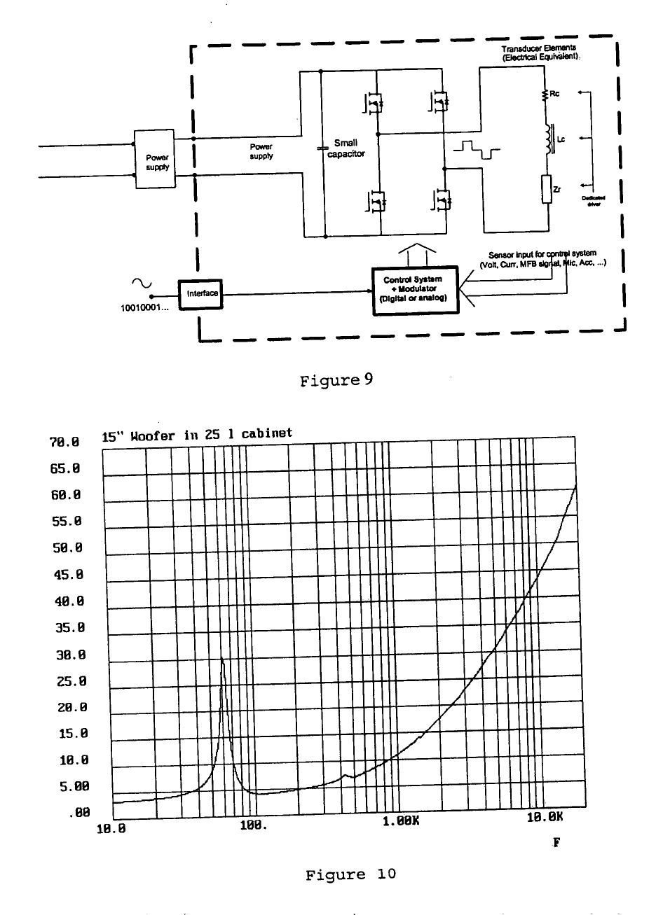

Another embodiment of the DC PMT is shown in FIG. 9 as described above comprising a PMT Power stage consisting of two half-bridges. The power supply can preferably be single ended and feed one or a plurality of PMT's. A small capacitor can also be inserted over the power stage terminals in order to meet the ripple requirements.

Galvanic isolation can be introduced in the Power supply or in the interface of the PMT. The galvanic isolation in the interface can preferably be introduced by optical means or by inserting a signal-transformer. This elegantly secures galvanic isolation of the complete audio power conversion chain.

The galvanic isolation in the Power supply can preferably be obtained by optical means or by the use of isolated transformers.

In order to overcome the high frequency losses in the electro-dynamic transducer the voice coil can preferably be designed such that the conductors forming the voice-coil are no more than ten times thicker than the penetration depth of the current in the conductors at the switching frequency. Preferably the conductors can be manufactured out of copper foil obtaining fewer turns on the voice-coil and at the same time lowering the impedance of the voice-coil. This implies lower supply voltage for the power stage in order to obtain the same output power. Therefore the PMT can also be used in low voltage applications such as battery-powered systems without comprising a boost stage. The low supply voltage will imply even lower losses in the power stage and in the transducer voice-coil and magnetic structure.

Furthermore the magnetic structure of the electromagnetic transducer, comprising bottom plate, magnet, top plate and center pole, or parts of said magnetic structure, can be implemented such that an outer layer is added to the magnetic structure. This layer can have a lower resistance at the switching frequency than the magnetic structure so that losses in the magnetic structure are reduced at the switching frequency.

Furthermore the magnetic structure can comprise ferrite materials in order to reduce high frequency losses in the magnetic system.

Since the output filter is eliminated problems due to peaking with fatal breakdown as a result is eliminated and the need for a zobel network in order to be able to damp the filter peaking is no longer present. This leads to a more efficient and stable system.

Furthermore, the output impedance of the PWM generator is lower than the output impedance of an equivalent class D amplifier due to the elimination of the output filter. This gives the PWM generator superior handling of the loudspeaker compared to the class d amplifier including an output filter. The inter-modulation, distortion, weight, volume and bandwidth limitations can be reduced.

Furthermore, all herein shown embodiments of the invention except the AC single stage PMT can be fed by a power supply capable of delivering multiple output voltages for the power stage, the control system can comprise means for gain shifting in order to obtain an improved system when it comes to efficiency, dynamic range and EMI as described in the applicant's Swedish patent application No. 0104403-1 entitled “Attenuation control for digital power converter”, hereby incorporated by reference.

The PWM generator can preferably be adapted to the electro-dynamic transducer characteristics as shown in FIG. 10, in order to obtain further electrical integration. The transducer should be driven by a pulse signal with a frequency as high as possible in order to drive the transducer in an efficient way. The above limit for the switching frequency is the efficiency of the PWM generator power stage and EMI.

It is clear that the skilled person may find modifications of the above described preferred embodiments, and such modifications should be considered as included in the scope of the appended claims. For example, the details regarding the switching stage design and feedback control should be regarded as an example only.

The PMT concept is general and independent upon application (may be anything from a few hundred mW to a 10 kW high power transducer). As such the PMT can be advantageously used in applications as consumer audio, professional audio, Car-Fi, Mobile Terminals and other portable low power equipment. PMT is universally applicable in audio applications.

The PMT naturally facilitates system design, e.g. of active speakers and subwoofers. A three-way active speaker system would comprise a bass, midrange and tweeter PMT unit driven by mains and e.g. a digital input source. The only visible electronics in the system would be the PCB controlling the PMT's and interface functions. Some of this signal processing could also be included into an intelligent PMT system having its own DSP core. This would virtually automate active loudspeaker design.

1. An apparatus for converting an audio signal from a source (25) into audio waves, comprising
a modulator (17), for modulating said audio signal,
an amplifying switching stage (15), for amplifying a modulated audio signal supplied from the modulator, and
electric-acoustic conversion means (19) connected to the switching stage, arranged to convert a pulse train (18) from the switching stage into audio waves,
wherein said electro-acoustic conversion means are driven directly by said pulse train without any separate filtering, and
wherein the modulator (17), the switching stage (15) and the conversion means (19) are integrated mechanically and electrically in one operational unit, being connectable directly to a mains power supply (12) or directly to mains.

2. An apparatus according to claim 1, wherein the transducer is optimized with the switching stage to minimize high frequency losses.

3. An apparatus according to claim 1, said switching stage (15) comprising PWM switching technology.

4. An apparatus according to claim 1, comprising a feedback loop supplying said modulator with feedback (26) from output variables from the conversion means.

5. An apparatus according to claim 1, wherein said pulse train (18) is a multi-level signal, preferably a three level signal.

6. An apparatus according to claim 1, wherein said electromagnetic conversion means has a magnetic structure comprising two layers of material, where a first, outer layer has a lower electrical resistance than a second, inner layer, and has a thickness much smaller than the thickness of the inner layer.

7. An apparatus according to any of the preceding claims, wherein a magnetic structure of said electro-magnetic conversion means comprises ferrite materials.

8. An apparatus according to any of the preceding claims, further comprising a voice-coil with conductors that have a diameter/thickness that is less than ten times greater than the penetration depth of a current through the conductors at the frequency of the pulse modulated signal.

9. An apparatus according to claim 8, wherein said conductors are manufactured of copper foil.

10. An apparatus according to any of the preceding claims, comprising isolation (27) of the input to secure isolation of the PMT.

11. An apparatus according to any of the preceding claims, wherein the power processing electronics is implemented on a substrate, said substrate utilizing the transducer itself for cooling.

12. An apparatus according to any of the preceding claims, adapted to be driven by an AC power supply (12) placed either externally or internally to the PMT.

13. An apparatus according to any of the preceding claims, adapted to be driven by a DC power supply placed either externally or internally to the PMT.
